(19) United States
(12) Patent Application Publication
(10) Pub. No.: US 2016/0054268 A1
(43) Pub. Date: Feb. 25, 2016

(54) PASSIVE BUBBLE MINIMIZATION IN ULTRASONIC TESTING

(71) Applicant: ATOMIC ENERGY OF CANADA LIMITED, Chalk River (CA)

(72) Inventor: Robert Hayden LUMSDEN, Petawawa (CA)

(73) Assignee: ATOMIC ENERGY OF CANADA LIMITED, Chalk River, ON (CA)

(21) Appl. No.: 14/781,004

(22) PCT Filed: Mar. 28, 2014
(86) PCT No.: PCT/CA2014/050321

§ 371 Date: Sep. 28, 2015

Related U.S. Application Data
(60) Provisional application No. 61/806,196, filed on Mar. 28, 2013.

(51) Int. Cl. G01N 29/24

(52) U.S. Cl. CPC G01N 29/24; G01N 2291/101

(57) ABSTRACT

To avoid the detrimental effects of bubbles in the carrying out of immersion ultrasonic testing, various surfaces may be coated with a coating that includes appropriately selected compounds. Such compounds may include those compounds that cause higher local surface tension and those compounds that are hydrophilic. Furthermore, various surfaces involved in the testing may be coated in a manner that minimizes cavities and crevices to which air bubbles can adhere.

### FIELD

This application claims the benefit of and priority to U.S. Provisional patent application Ser. No. 61/806,196, filed Mar. 28, 2013, under the title PASSIVE BUBBLE MINIMIZATION IN ULTRASONIC TESTING. The content of the above patent application is hereby expressly incorporated herein by reference into the detailed description hereof.

The present application relates generally to Ultrasonic Testing and, more specifically, to passive bubble minimization in ultrasonic testing.

### BACKGROUND

Immersion Ultrasonic Testing (UT) requires a couplant between a transducer and an inspected material to facilitate transmission of sound into the inspected material. Couplant media can be water, heavy water, oil, glycerin-based liquid or other liquid.

### BRIEF DESCRIPTION OF THE DRAWINGS

Reference will now be made, by way of example, to the accompanying drawings which show example implementations; and in which:

FIG. 1 illustrates an inspection tool including an Immersion Ultrasonic Probe and, as shown in cross-section, a probe holder for the Immersion Ultrasonic Probe.

### DETAILED DESCRIPTION

To avoid the detrimental effects of bubbles in the carrying out of immersion ultrasonic testing, various surfaces may be coated with appropriately selected compounds. Such compounds may include those compounds that cause higher local surface tension and those compounds that are hydrophilic.

According to an aspect of the present disclosure, there is provided an Immersion Ultrasonic Testing device including an Immersion Ultrasonic Probe having a face and a bubble minimization coating adhered to the face of the Immersion Ultrasonic Probe.

Other aspects and features of the present disclosure will become apparent to those of ordinary skill in the art upon review of the following description of specific implementations of the disclosure in conjunction with the accompanying FIGURE.

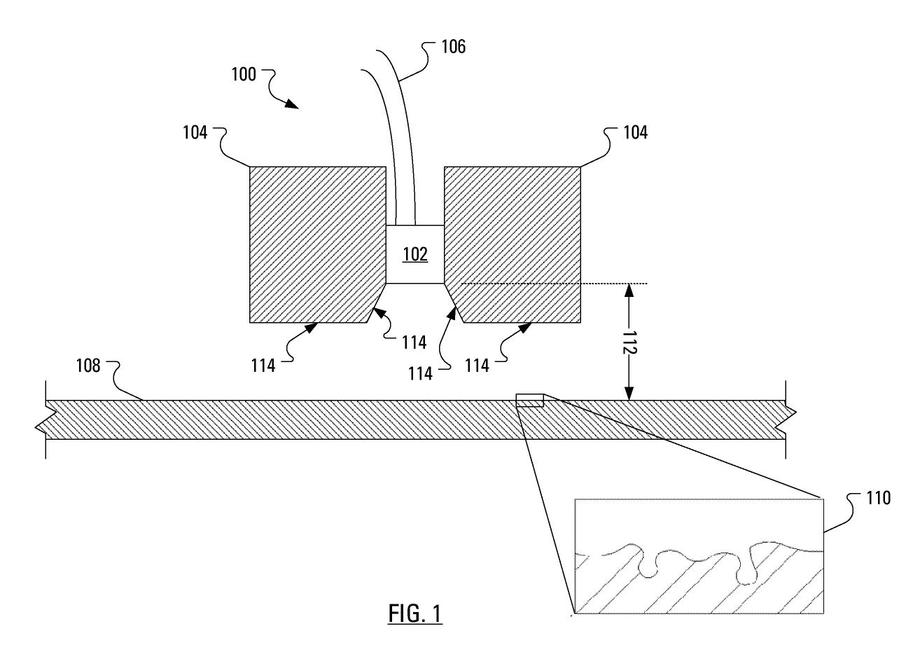

FIG. 1 illustrates an inspection tool 100 including an Immersion Ultrasonic Probe 102 and, as shown in cross-section, a probe holder 104 for the Immersion Ultrasonic Probe 102. In preparation for use, a first data connection (not shown) may be made between the Immersion Ultrasonic Probe 102 and an ultrasonic instrument (not shown) via a conduit 106. As is typical, an acquisition system may include a processor, various types of short term and long term memory as well as various input and output interfaces. The acquisition system could just be a hand held unit with a screen (no saved data) or a full computer with ultrasonic instruments or ultrasonic pulser cards data acquisition cards and other control systems for data capture. An hydraulic connection (not shown) may also be made between the probe holder 104 and a supply of a liquid couplant. Alternatively, the inspection surface could have just been flooded or the inspected part could be placed in a tank/pool of water.

FIG. 1 also illustrates an inspection surface 108. Additionally, a magnification 110 of roughness and pockets inspection surface 108 is illustrated to emphasize features of the inspection surface 108 where air bubbles can latch.

In operation, the liquid couplant supplied to the probe holder 104 is output by the probe holder 104 to fill a distance 112 between a face of the Immersion Ultrasonic Probe 102 and the inspection surface 108. As mentioned hereinbefore, the inspection surface 108 may be submersed in a pool of liquid in a tank or an inspection may take place inside a pipe filled with water. The couplant facilitates transmission of sound from the Immersion Ultrasonic Probe 102 into the inspection surface 108. The couplant also facilitates transmission of reflected sound from the inspection surface 108 to the Immersion Ultrasonic Probe 102. During testing, the reflected sounds are detected at the Immersion Ultrasonic Probe 102 and data representative of the detected sound is transmitted, by the Immersion Ultrasonic Probe 102 to the ultrasonic instrument.

So-called “Wetted Surfaces” of probe holder 104 of the inspection tool 100 are associated, in FIG. 1, with a reference numeral 114.

Air bubbles can stick to the face of the Immersion Ultrasonic Probe 102. Air bubbles can also exist throughout the couplant. Air bubbles are known to attenuate the UT signal and/or add noise to data collected during testing.

One solution to the air bubble problem is to add chemicals, such as surfactants, to the couplant. Such surfactants act to reduce the quantity of bubbles in the couplant. Another solution to the air bubble problem is to use a liquid jet to maintain the face of the Immersion Ultrasonic Probe 102 clear of air bubbles. Still Another solution to the air bubble problem is to use pressure gradients to cause flows that remove trapped gases.

Inconveniently, in the existing solutions that require addition of chemicals to the couplant, such additional chemicals may harm the inspection surface 108 or the inspection tool 100. Furthermore, the existing solutions that require the addition of systems, such as jets, to the inspection tool 100 add to bulk and complexity of the inspection tool 100.

In overview, it is proposed herein to use sealants, compounds or other surface finishes or surface treatments to reduce the latching of air bubbles to the face of the Immersion Ultrasonic Probe 102, to the inspection surface 108 and/or to the wetted surfaces 114 of the inspection tool 100.

Coatings and compounds that may be considered suitable for reducing air bubbles include those that increase local surface tension and those that are qualified as “hydrophilic” for the liquid used for the couplant.

It is proposed herein, in one embodiment of the present application, to adhere to the face of the Immersion Ultrasonic Probe 102 a coating. The coating may, for example, be a compound that causes higher local surface tension.

In the event that only a portion of a bubble rests on the coated face of the Immersion Ultrasonic Probe 102, it is expected that the result will be non-uniform loading of the bubble surface. Consequently, the bubble will move away from the coated face of the Immersion Ultrasonic Probe 102 in such a way as to bring the surface loading of the bubble back to an equilibrium state and, in this way, reclaim a spherical geometry for the bubble. As the bubble acts to reclaim a spherical geometry, the bubble conveniently moves away from the coated face of the Immersion Ultrasonic Probe 102.

Notably, instead of, or in addition to, coating the face of the Immersion Ultrasonic Probe 102 with a compound that causes higher local surface tension, the wetted surfaces 114 and the inspection surface 108 may also be coated with a compound that causes higher local surface tension.

Hydrophilic materials attract water. It is proposed herein, in one embodiment of the present application, to adhere to the face of the Immersion Ultrasonic Probe 102 a coating. The coating may, for example, be a hydrophilic compound. It is expected that the hydrophilic compound will cause fluid to move toward the coated face of the Immersion Ultrasonic Probe 102, thereby forcing air bubbles away from the coated face of the Immersion Ultrasonic Probe 102.

Titanium dioxide, is one example of a compound with hydrophilic properties. Accordingly, in one embodiment of the present application, the face of the Immersion Ultrasonic Probe 102 may be coated with titanium dioxide. Selection of an appropriate hydrophilic compound depends on the fluid being used as a couplant and any chemical interactions that may be expected to occur between the hydrophilic compound and the inspection surface 108.

Scratch resistance is a feature beneficial for the long term usefulness for minimizing air bubbles. In addition to being hydrophilic, titanium dioxide also has a suitable scratch resistance.

Notably, instead of, or in addition to, coating the face of the Immersion Ultrasonic Probe 102 with a hydrophilic compound, the wetted surfaces 114 and the inspection surface 108 may also be coated with a hydrophilic compound.

In a surface finishing approach to air bubble minimization, as in the coating approach, the goal is to create a surface to which bubbles are unlikely to remain attached.

The surfaces that are candidates for such surface finishing include the face of the Immersion Ultrasonic Probe 102, the wetted surfaces 114 and the inspection surface 108.

It is known that the fewer cavities or crevices in a surface to a bubble may attach when immersed in a liquid, the fewer bubbles will remain on the surface of a coating.

The different methods suggested to mitigate this issue relate to a passive approach, meaning that beyond the application of the compound or coating, or any required re-application or general maintenance, the removal of bubbles will continue unabated. General maintenance may be required to clean built-up residue off the treated surfaces. These residues could be from foreign compounds/chemicals that have mixed with the couplant during inspection of the inspection surface.

The above-described implementations of the present application are intended to be examples only. Alterations, modifications and variations may be effected to the particular implementations by those skilled in the art without departing from the scope of the application, which is defined by the claims appended hereto.

What is claimed is:

1. An Immersion Ultrasonic Testing device comprising:
an Immersion Ultrasonic Probe having a face; and
a bubble minimization coating adhered to the face of the Immersion Ultrasonic Probe.

2. The device of claim 1 further comprising a probe holder adapted to hold the Immersion Ultrasonic Probe.

3. The device of claim 2 wherein the probe holder defines wetted surfaces, the device further comprising a further bubble minimization coating adhered to the wetted surfaces.

4. The device of claim 1 wherein the bubble minimization coating comprises a compound that causes higher local surface tension.

5. The device of claim 1 wherein the bubble minimization coating comprises a hydrophilic compound.

6. The device of claim 5 wherein the hydrophilic compound comprises titanium dioxide.

7. An Immersion Ultrasonic Testing device comprising:
an Immersion Ultrasonic Probe having a face; and
a probe holder adapted to hold the Immersion Ultrasonic Probe, the probe holder defining wetted surfaces, the wetted surfaces finished to minimize cavities and crevices.
